(19) United States
(12) Patent Application Publication
(10) Pub. No.: US 2013/0009853 A1
(43) Pub. Date: Jan. 10, 2013

(54) EYE-GLASSES MOUNTED DISPLAY

(75) Inventors: Lambertus Hesselink, Atherton, CA (US); Yuzuru Takashima, Cupertino, CA (US)

(73) Assignee: The Board of Trustees of the Leland Stanford Junior University, Palo Alto, CA (US)

(21) Appl. No.: 13/542,076

(22) Filed: Jul. 5, 2012

Related U.S. Application Data
(60) Provisional application No. 61/504,661, filed on Jul. 5, 2011.

(51) Int. Cl. G09G 5/00

(52) U.S. Cl. 345/8

(57) ABSTRACT

A display system is provided. An eye-glass is provided. A projector is provided comprising a display device and an optical system for directing an image from the display device to reflect off of the eye-glass and into an eye. The eye-glass and projector may be supported by a frame, which is able to be mounted on a head.

### CROSS REFERENCE TO RELATED APPLICATIONS

This application claims priority under 35 U.S.C. §119(e) from co-pending U.S. Provisional Application No. 61/504,661, entitled “EYE-GLASSES MOUNTED DISPLAY”, filed Jul. 5, 2011, by Lambertus Hesselink et al.

### BACKGROUND OF THE INVENTION

This invention relates generally to wearable head-up displays. Conventional wearable head-up displays may require heavy and bulky prism optics, scanning device, and image combiner. Displays that require laser scanners are expensive.

### SUMMARY OF THE INVENTION

In accordance with the invention a display system is provided. An eye-glass is provided. A projector is provided comprising a display device and an optical system for directing an image from the display device to reflect off of the eye-glass and into an eye.

In another manifestation of the invention, a display system is provided. A glasses frame is provided comprising a mount for supporting the glasses frame on a head. A first eye-glass is supported by the glasses frame. A second-eye glass is supported by the glasses frame. A projector is supported by the frame and comprises display device and an optical system for directing an image from the display device to reflect off of the first eye-glass and into an eye. A communication device is electrically connected to the projector.

In another manifestation of the invention, a method for providing information to a person wearing a head-up display system is provided. A location of the person is determined. Information related to the location of the person is received. The information from a projector, which is part of the head-up display system, is projected. The information from the projector is reflected off of a partially reflecting eye-glass, which is part of the head-up display, into an eye of the person, so that the information from the projector is superimposed over a view passing through the eye-glass.

The invention and objects and features thereof will be more readily apparent from the following detailed description and appended claims when taken with the drawings.

### BRIEF DESCRIPTION OF THE DRAWINGS

FIG. 1 is a schematic view of an embodiment of the invention.

FIG. 2 shows an example of the grating pitch.

FIGS. 3A-B show different examples of optical design.

FIG. 4 is a schematic view of an implementation of an embodiment of the invention that provides a virtual image display.

FIG. 5 is an image that would be provided by an embodiment of the invention.

FIG. 6 is a schematic illustration of an embodiment of the invention for wearable head-up displays.

### DETAILED DESCRIPTION OF ILLUSTRATED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

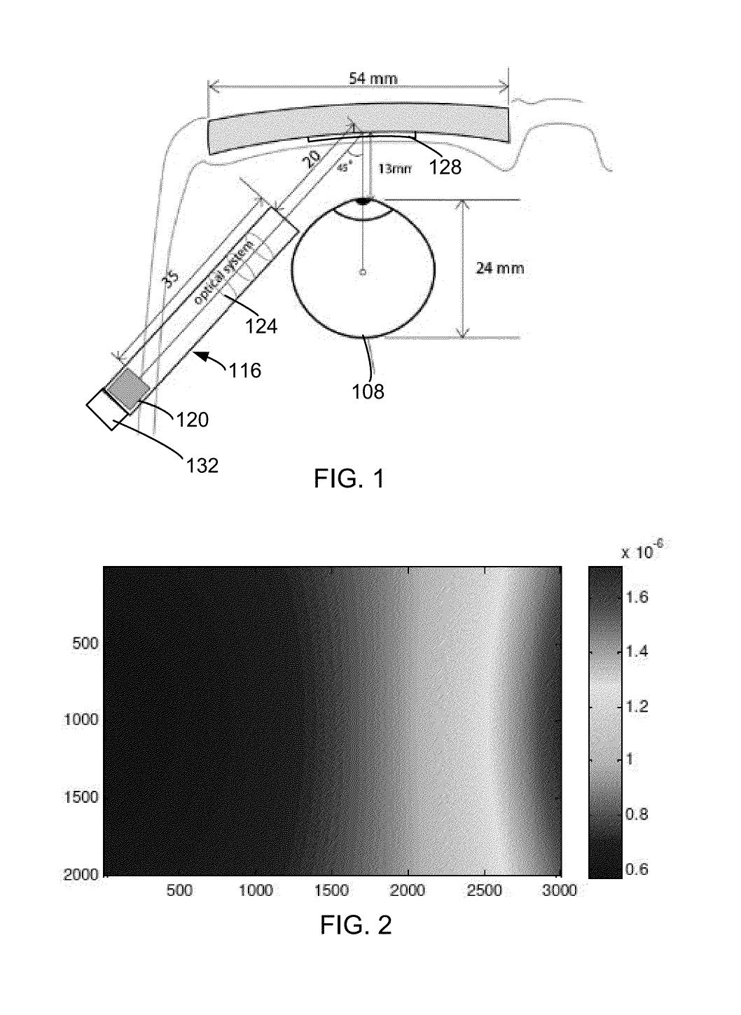

FIG. 1 is a schematic view of an embodiment of the invention. In FIG. 1 a display system 104 provides image is provided to an eye 108. The display system 104 comprises an eye-glass 112 and a projector 116. The projector comprises a display device 120 and an optical system 124 for directing an image from the display device 120 to reflect off of the eye-glass 112 and into the eye 108. Preferably, at least one surface of the eye-glass 112 is modified so that the surface is reflective or anti-reflective of the image from the display device 120. Such a modification may be provided by the application of a beam combiner film 128. A communication device 132 such as a Bluetooth device is electrically connected to the display device 120 to provide data for the images that are generated.

### Example of Real Image Projection Display

In one example of the invention, the display system 104 provides a real image within the eye 108. In this example the beam combiner film 128 is a holographic optical element (HOE) beam combiner film, which is laminated to the interior surface of the eye-glass 112 to provide the surface modified to be partially-reflective of the image from the display device 120. In other embodiments, the modified surface may be a surface relief hologram formed by using two-photo-polymer methods or forming a surface relief hologram using two-photo-polymer methods. Photo-polymer methods apply a polymer patterned, as a beam combiner film, which uses light for hardening. In this example, the display device 120 may be a liquid crystal display, illumination optics, and a light source. Light from the display device 120 is reflected and focused to create a real image on the retina of the eye 108. The conjugate image of the real image on the retinal is located at least as far as the accommodation distance of human eye, such as more than 250 mm from the eye. In other embodiments the photo-polymer may be used to provide a tilted reflecting surface. Other coatings may provide other beam combiner films. Other methods such as etching may be used to form the grating.

A distinct part of this embodiment of the invention is the eye glass used as an image combiner, which enables superposition of projected and see-through images without relying on bulky prisms or beam splitting device. The reflection of rays at the surface of the eye-glasses is not a specular reflection, therefore an additional optical property which enables non specular reflection is provided. The holographic optical element attached on the surface of the eye-glasses is one possible way to enable non-specular reflection on the surface of eye glasses. To superimpose a projected image on top of the see-through images requires that all the rays from the projector go through the pupil of eyeball. This requirement leads to a non-uniform grating pitch of the HOE.

FIG. 2 shows an example of the grating pitch. The size of HOE is 2×3 mm. The grating pitch varies 0.7 um to 1.6 mm, which is feasible to fabricate by using lithography and semiconductor process, or exposure of photo-sensitive material using pre-distorted wave fronts in a form of volume or thin hologram. The FOV of the HOE is ±10 degrees.

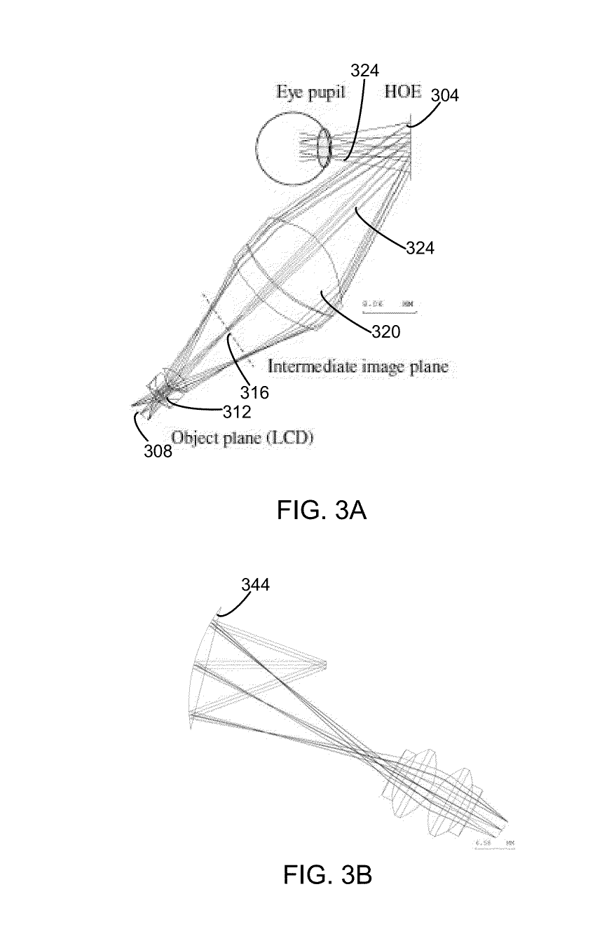

FIG. 3A shows an example of an optical design with a HOE 304, as described above, employed. At the object plane, a display device 308 is placed and may be illuminated by a light source, which is not shown. Lenses 312 located next the object plane form an intermediate image on an intermediate image plane 316. The intermediate image forms image on an intermediate plane, which is at a distance at least larger than the accommodation distance measured from the eye. In this example, the intermediate image plane is more than 250 mm away from the retina of the eye along an optical path 324, which is the path that the light of the image takes to travel to the retina of the eye. To form the image in the eye, a secondary lens 320 is employed. Thus the imaging system is a cascaded optical system which comprises of the real image formation and infinite or virtual image formation. Finally the HOE 304 redirects the infinite or virtual image towards the eye while adjusting angle of reflection by tuning the spacing of the grating as is depicted in FIG. 2. Note that the object plane and the secondary optics are tilted and or shifted to partially compensate aberrations induced by the HOE. FIG. 3B shows an alternative embodiment by using a tilted eye glass of an auxiliary tilted meniscus and semi-transparent mirror 344 instead of a HOE. In this embodiment, the remaining optical configuration is exactly same as the embodiment depicted in FIG. 3A.

### Example of an Image Projection Display without Using an Intermediate Image

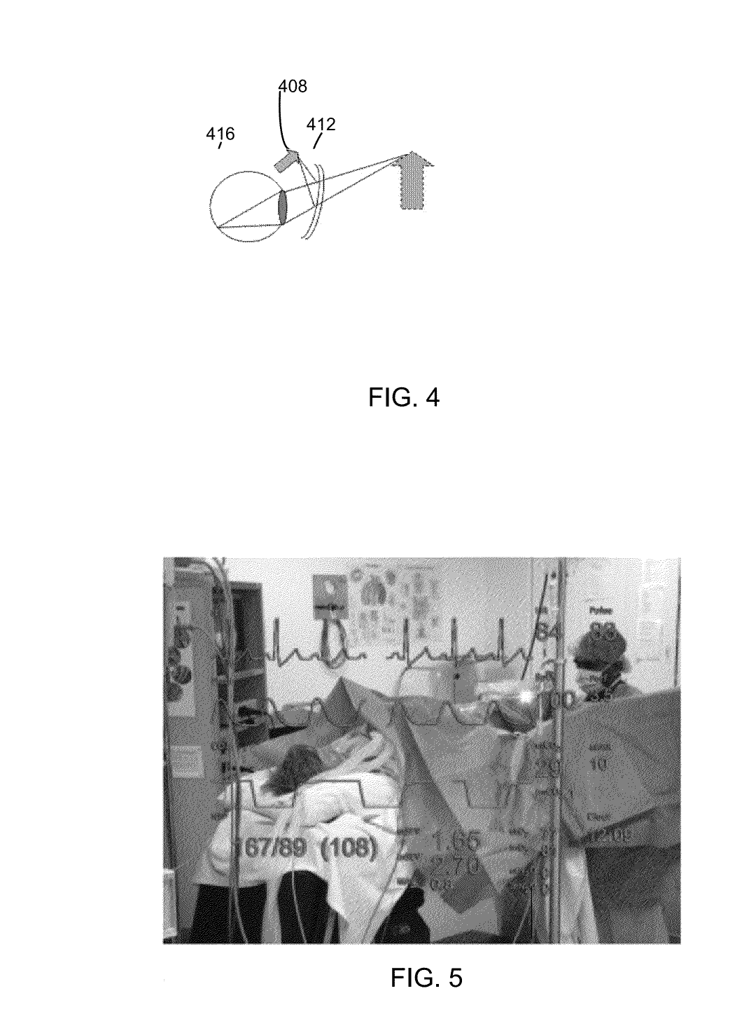

An image projection glasses mounted display without using an intermediate image is shown in FIG. 4, which is a schematic view of an implementation of an embodiment of the invention that provides a virtual image display. The virtual image projection display 408 utilizes the curved surface of the eye glasses 412 as a magnifier. The surface of eye glasses 412 curves towards the viewer's eye 416. Such a curved reflection surface has a positive focal length of R/2 where R is radius of curvature of the inner surface of eyeglasses. When the object to glass surface distance is shorter then R/2, a virtual image is formed at the opposite side of the eye glasses. Thus, the image formed by display device and the see through images are superimposed. The reflectivity of the glass surface can be controlled by applying an appropriate coating on the surface to eliminate dual images due to the reflections of the first and second surface of eye glasses. Thus, the curved surface works as a positive lens with a beam combiner, which superimposes an image formed by the positive lens with objects observed through the eye glass. The projection display 408 may comprise a LCD display, DMD display, or LED arrays.

In an embodiment of the invention, the eye-glass provides one lens for each eye. In such an embodiment, two separate images may be provided so that each image is reflected off of only one lens so that each image is provided for only one eye. Such embodiments may provide a stereoscopic system. Other embodiments may provide a single image that is reflected off of both lenses so that a single image is provided for both eyes. Other embodiments of the invention may provide a single image for a single eye. Such embodiments may use a monocle. Embodiments of the invention may be an entire display system or may be a system that clips on to conventional eye-glasses.

An embodiment of the invention may provide a reflective coating on an inner surface of the eye-glasses closest to the eye and an anti-reflective coating on the outer surface. The anti-reflective coating helps prevent the production of a double image caused by a reflection from the outer surface of the eye-glass caused by total internal reflection. Another embodiment of the invention uses half silvered mirrors for the conditioning of the eye-glass.

Embodiments of the invention may be used to display information, such as incoming calls, text messages, or navigation data via a cell phone. Other embodiments of the invention may be used for medical purposes, such as displaying a patient's vital conditions during surgery or the location of blood vessels during the insertion of a needle for anesthesia. FIG. 5 is an illustration that shows how medical data may be displayed by an embodiment of the invention, while medical personnel view a patient related to the medical data. Other embodiments of the inventions may be used as reading aid devices (RAD) for people having eye problems. In such embodiments, a camera may grab an image of a book a user is currently reading. Character recognition software would extract text information or, if the title of the book is known, text data is retrieved from a database or via the Internet. Other embodiments of the invention may be used as viewing aid devices (VAD). A camera grabs an image of scenery that a user is currently viewing. The image grabbed by the camera is superimposed on the scenery of the viewer's interest allowing recognition of details of the scenery.

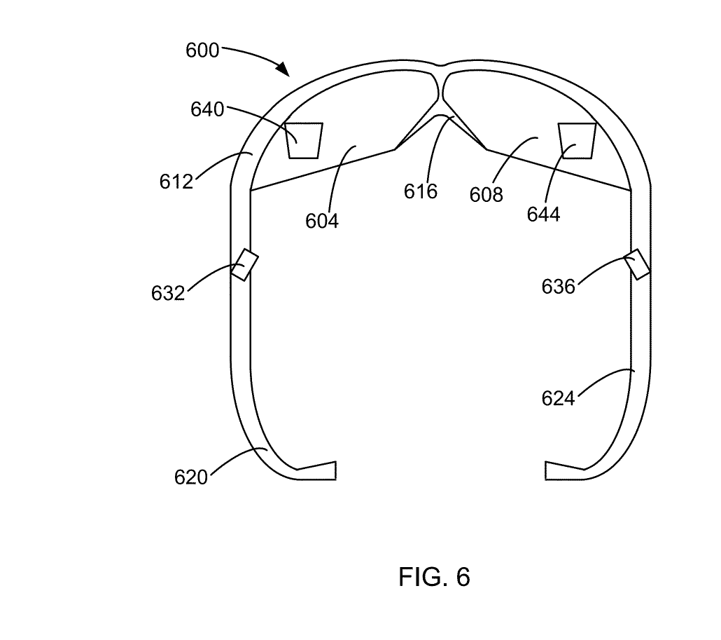

FIG. 6 is a schematic illustration of an embodiment of the invention for wearable head-up displays 600. The wearable head-up displays 600 provide glasses with a first eye piece 604 and a second eye piece 608. A frame 612 comprises a support for the first eye piece 604 and the second eye piece 608, a nose pad 616, a first ear hook 620 and a second ear hook 624. A first projector 632 is supported by the first ear hook 620 and a second projector 636 is supported by the second ear hook 624. A first beam combiner film 640 is on a surface of the first eye piece 604. A second beam combiner film 644 is on a surface of the second eye piece 608. Although in this example the combiner films 640, 644 are square, they are shown as non-square due to curvature of the first and second eye pieces 604, 608 and the perspective view. The first ear hook 620 and second ear hook provide a mount part of the frame for mounting the wearable head-up display 600 on the head. In other embodiments the ear hooks may be replaced by a strap, where the strap is a non-rigid part of the frame for mounting a system on the head.

Because embodiments of the invention use a surface of eye-glasses with a beam combiner to reflect the image, embodiments of the invention provide GMD's that are less bulky and less expensive that enable deeply immersive environments with no destructive components. Embodiments of the invention provide a relatively wide field of view of ±20 degrees and are able to display text or images or a combination of both. Embodiments of the invention are less bulky and less expensive because they do require free-form prisms and laser scanners.

In embodiments of the invention, a cell phone or other portable device may be used to communicate with the communication device, so that the display device displays information from the cell phone or other portable device. In other embodiments, the communication device may directly communicate with the Internet or a computer network.

While this invention has been described in terms of several preferred embodiments, there are alterations, permutations, modifications and various substitute equivalents, which fall within the scope of this invention. It should also be noted that there are many alternative ways of implementing the methods and apparatuses of the present invention. It is therefore intended that the following appended claims be interpreted as including all such alterations, permutations, modifications, and various substitute equivalents as fall within the true spirit and scope of the present invention.

What is claimed is:

1. A display system, comprising:
an eye-glass;
a projector, comprising:
a display device; and
an optical system for directing an image from the display device to reflect off of the eye-glass and into an eye.

2. The display system, as recited in claim 1, further comprising a conditioning on the eye-glass that is partially reflective of the image from the display device.

3. The display system, as recited in claim 2, wherein the conditioning is an etching of a surface of the eye-glass.

4. The display system, as recited in claim 2, wherein the conditioning is a beam combiner film on a surface of the eye-glass.

5. The display system, as recited in claim 4, wherein the eye-glass is monocular.

6. The display system, as recited in claim 4, wherein the eye-glass is binocular.

7. The display system, as recited in claim 4, further comprising a communication device electrically connected to the display device.

8. The display system, as recited in claim 4, wherein the beam combiner film is a photo-polymer.

9. The display system, as recited in claim 4, wherein the beam combiner film provides a holographic optical element beam combiner.

10. The display system, as recited in claim 8, wherein the optical system comprises:
a first lens system adjacent to the display device for creating an intermediate image in an intermediate image plane more than 250 mm from a retina of the eye along an optical path; and
a secondary lens system on an opposite side of the intermediate image plane from the display device and first lens system.

11. The display system, as recited in claim 4, further comprising a frame for supporting the display system on a head.

12. The display system, as recited in claim 1, wherein the eye-glass is an auxiliary tilted meniscus and semitransparent minor.

13. The display system, as recited in claim 1, wherein the optical system comprises:
a first lens system adjacent to the display device for creating an intermediate image in an intermediate image plane more than 250 mm from a retina of the eye along an optical path; and
a secondary lens system placed on an opposite side of the intermediate image plane from the display device and first lens system.

14. The display system, as recited in claim 1, further comprising a frame for supporting the display system on a head.

15. The display system, as recited in claim 1, further comprising a communication device electrically connected to the display device.

16. A display system, comprising:
a glasses frame, comprising a mount for supporting the glasses frame on a head;
a first eye-glass supported by the glasses frame;
a second-eye glass supported by the glasses frame;
a projector, supported by the frame, comprising:
a display device; and
an optical system for directing an image from the display device to reflect off of the first eye-glass and into an eye; and
a communication device electrically connected to the projector.

17. The display system, as recited in claim 16, further comprising a conditioning on the first eye-glass that is partially reflective of the image from the display device.

18. The display system, as recited in claim 17, wherein the conditioning is a beam combiner film on a surface of the eye-glass.

19. A method for providing information to a person wearing a head-up display system, comprising:
determining a location of the person;
receiving information related to the location of the person;
projecting the information from a projector, which is part of the head-up display system;
reflecting the information from the projector off of a partially reflecting eye-glass, which is part of the head-up display, into an eye of the person, so that the information from the projector is superimposed over a view passing through the eye-glass.
